(19) United States
(12) Patent Application Publication
(10) Pub. No.: US 2024/0095206 A1
(43) Pub. Date: Mar. 21, 2024

(54) ASSYMMETRICAL DATA RATES FOR HIGH SPEED INTERCONNECTS

(71) Applicant: Intel Corporation, Santa Clara, CA (US)

(72) Inventors: Sampath Dakshinamurthy, Bangalore (IN); Pooja Jadhav, Davanagere (IN); Neethumol O.U., Kerala (IN); Lakshmipriya Seshan, Sunnyvale, CA (US)

(73) Assignee: Intel Corporation, Santa Clara, CA (US)

(21) Appl. No.: 18/525,289

(22) Filed: Nov. 30, 2023

(51) Int. Cl. G06F 13/42

(52) U.S. Cl. CPC G06F 13/4273; G06F 2213/0064

(57) ABSTRACT

Embodiments described herein may include apparatus, systems, techniques, or processes that are directed to semiconductor interconnects, such as on-package die-to-die (D2D) interconnects, for example. Specifically, embodiments herein may relate to on-package D2D interconnects for memory that use or relate to the Universal Chiplet Interconnect Express (UCIe) adapter or physical layer (PHY). Other embodiments are described and claimed.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc.

As a result of the greater ability to fit more processing power in smaller packages, smaller computing devices have increased in popularity. Smartphones, tablets, ultrathin notebooks, and other user equipment have grown exponentially. However, these smaller devices are reliant on servers both for data storage and complex processing that exceeds the form factor. Consequently, the demand in the high-performance computing market (e.g. server space) has also increased. For instance, in modern servers, there is typically not only a single processor with multiple cores, but also multiple physical processors (also referred to as multiple sockets) to increase the computing power. But as the processing power grows along with the number of devices in a computing system, the communication between sockets and other devices becomes more critical.

In fact, interconnects have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a first system in accordance with one embodiment.

FIG. 2 illustrates an interconnect stack in accordance with one embodiment.

FIG. 3 illustrates link initialization logic flow in accordance with one embodiment.

FIG. 4 illustrates an initialization logic flow in accordance with one embodiment.

FIG. 5 illustrates second system in accordance with one embodiment.

FIG. 6 illustrates a third system in accordance with one embodiment.

FIG. 7 illustrates a logic flow in accordance with one embodiment.

FIG. 8 illustrates a fourth system in accordance with one embodiment.

FIG. 9 illustrates a top view of a semiconductor package in accordance with one embodiment.

FIG. 10 illustrates computer-readable storage medium in accordance with one embodiment.

### DETAILED DESCRIPTION

Embodiments described herein may include apparatus, systems, techniques, or processes that are directed to high-speed semiconductor interconnects. Some embodiments are particularly directed to on-package die-to-die (D2D) interconnects. Specifically, embodiments herein may relate to on-package D2D interconnects for memory that use or relate to the Universal Chiplet Interconnect Express (UCIe) protocol layer, D2D adapter, or physical layer (PHY).

Embodiments are generally directed to improvements for interconnects suitable to communicate information between semiconductor dies arranged in on-package memory architectures. Some embodiments are particularly directed to implementing an interconnect such as a Universal Chiplet Interconnect Express (UCIe™) interconnect as defined by a Universal Chiplet Interconnect Express (UCIe™) specification promulgated by the UCIe Consortium, such as the UCIe specification, version 1.1, Aug. 8, 2023, along with any progeny, revisions and variants (collectively referred to as the “UCIe Specification”). Although some embodiments implement a UCIe interconnect, it may be appreciated that other semiconductor interconnects defined by other semiconductor specifications may be used as well. Embodiments are not limited in this context.

In general, UCIe is an open industry standard interconnect offering high-bandwidth, low-latency, power-efficient, and cost-effective on-package connectivity between chiplets, which are specialized integrated circuits (ICs). Although the UCIe interconnect is primarily designed to handle communications between chiplets, embodiments implement techniques to extend the UCIe interconnect to manage communications between any types of semiconductor dies, sometimes referred to as semiconductor devices or simply devices. Examples of devices include without limitation central processing unit (CPU) dies, memory dies such as dynamic random access memory (DRAM) and flash memory, graphics processing unit (GPU) dies, sensor dies, power management integrated circuit (PMIC) dies, system-on-a-chip (SoC) dies, and so forth. For example, a UCIe interconnect may transport information between a SoC and one or more memory ICs, referred to as memory chips. The SoC and the memory chips are implemented as separate semiconductor dies on a same semiconductor package in various architectures. The SoC and the memory chips each implement UCIe interfaces and associated interface logic to allow the SoC and the memory chips to communicate standard memory signals as UCIe signals transported over the UCIe interconnect. This allows a unified solution to scale on-package memory to support various applications ranging from applications suitable for hand-held computers to high-performance computing (HPC) applications.

When two or more peer devices communicate over a UCIe interconnect, the peer devices may sometimes be referred to as “modules,” where a transmit device is referred to as a “module” and a receive device is referred to as a “module partner.” In many cases, the module and the module partner are capable of operating at different data rates. When this rate mis-match occurs, the devices may negotiate a least common multiple (LCM) between the different data rates to arrive at a negotiated data rate for the UCIe interconnect. A negotiated data rate is the result of a process by which two or more devices establish a mutual agreement on the maximum transmission speed at which they can reliably communicate with each other, sometimes referred to as a symmetrical data rate. A symmetrical data rate refers to a data transmission rate and/or a data receive rate that is the same or nearly equal to each other. This negotiation normally takes place during the initialization phase of the communication session. During this process, the semiconductor dies exchange information about their capabilities and determine the highest data rate they can both support without compromising the quality and integrity of the data transmission. The negotiated data rate ensures efficient and effective data transfer between devices while considering their respective capabilities and limitations. For example, assume one of the devices might operate at a maximum data rate of 16 giga-bits-per-second (Gbps) while the other semiconductor die might operate at a maximum data rate of only 12 Gbps, or vice-versa. The devices might negotiate a symmetrical data rate of 12 Gbps for all communications over the UCIe interconnect.

In some cases, however, peer devices might want to communication information over the UCIe interconnect using an asymmetrical data rate. An asymmetrical data rate refers to a data transmission rate and/or a data receive rate that are different from each other. Referring again to the previous example, assume one of the devices might operate at a maximum data rate of 16 Gbps while the other semiconductor die might operate at a maximum data rate of only 12 Gbps, or vice-versa. The devices might negotiate an asymmetrical data rate of 16 Gbps for a first device communicating over a first transmit channel of the UCIe interconnect, and 12 Gbps for a second device communicating over a second transmit channel of the UCIe interconnect, or the reverse for the first and second receive channels.

Modern on-chip or off-chip protocols, including the UCIe Specification, currently do not support asymmetrical data rates within a UCIe interconnect. For example, peripheral component interconnect express (PCIe) supports a width degradation option wherein the PCIe can transfer the data through a limited number of lanes instead of using all the data lanes. This option effectively reduces bandwidth of the UCIe interconnect, but does not allow for asymmetrical data rates. In another example, the unified parallel interface (UPI) protocol uses a fixed speed and bandwidth for transporting data between CPUs. Neither of these protocols have sideband support and hence they are not capable of supporting an asymmetric data rate option.

Embodiments are generally directed to techniques designed to achieve asymmetrical data rates within a UCIe interconnect on an on-package die-to-die (D2D) UCIe interface. The UCIe protocol provides a unique opportunity to implement asymmetrical data rates. This is because, at least in part, the UCIe protocol defines a separate sideband protocol to support initialization of a mainband for the UCIe interconnect. The mainband comprises a physical link that transports actual data traffic. One of the uses of the sideband protocol in the UCIe Specification is to exchange link parameters from one remote die to another remote die to establish a symmetrical data rate for mainband communications over the UCIe interconnect. Embodiments extend use the sideband protocol to establish an asymmetrical data rate for mainband communications over the UCIe interconnect. Further, embodiments use a forwarded clock feature of the sideband protocol to support the asymmetrical data rate.

The implementation of an asymmetric data rate for high-speed interconnects, such as a UCIe interconnect, provides several technical advantages. One technical advantage is that some applications executing on-die or off-die may have a specific need for asymmetrical bandwidth. For example, assume the previous case where one semiconductor die is a system-on-a-chip (SoC) and another semiconductor die is a memory chip in a same semiconductor package. The SoC may implement an application that performs memory read operations at a rate that is higher than memory write operations. In this case of core-to-memory interactions, more bandwidth may be required for read operations than write operations. Another technical advantage is that even though a link layer of one semiconductor die can operate at a higher data rate than another semiconductor die, the negotiated symmetric data rate determines the overall data rate and throughput of the D2D interactions. Therefore, the use of asymmetric data rates will improve an overall performance of the semiconductor dies and also the UCIe interconnect. In yet another technical advantage, the current UCIe Specification only supports a symmetric data rate during mainband initialization, which is typically the slowest speed of either die. Instead of using the slowest speed, the use of asymmetric data rates allow the peer dies to run at the highest data rate possible. Embodiments therefore result in increased system performance, lower compute costs, higher interconnect throughput, more efficient memory utilization, and improved resource allocation and utilization by a device, system, or application.

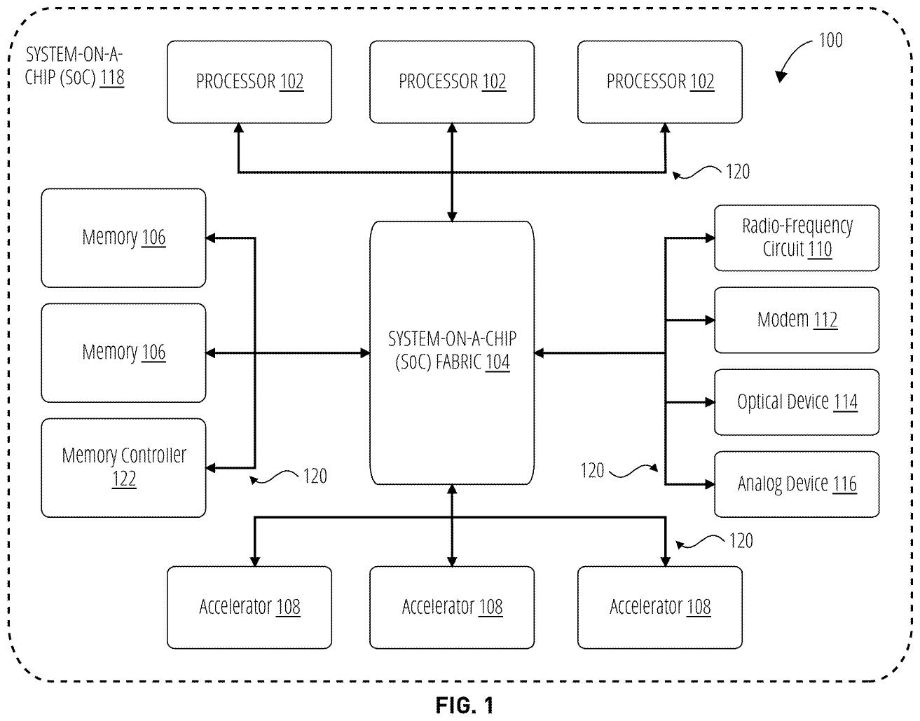

FIG. 1 illustrates an example of a system 100. System 100 may be an electronic system, such as a computing system, that implements one or more semiconductor devices on a semiconductor die in a system-on-a-chip (SoC) implementation. The semiconductor die may implement one or more interconnects and associated link protocols defined by a semiconductor specification, such as the UCIe Specification, for example. UCIe is an open industry standard interconnect offering high-bandwidth, low-latency, power-efficient, and cost-effective on-package connectivity between chiplets.

System 100 illustrates an example of multiple semiconductor devices in a SoC 118. System 100 illustrates a die level integration to deliver power-efficient and cost-effective performance. The SoC 118 can be integrated with other semiconductor dies at the package level with applicability from hand-held to high-end servers with dies from multiple sources connected through different packaging options even on the same package.

As depicted in FIG. 1, the SoC 118 includes one or more processors 102 and one or more memory 106 coupled to a SoC fabric 104. A processor 102 may include any processing element, such as a microprocessor, a host processor, an embedded processor, a co-processor, or other processor. Each processor 102 is coupled to SoC fabric 104 through a link 120, such as a front-side bus (FSB), for example. In one embodiment, the link 120 is a serial point-to-point interconnect as described below. In another embodiment, link 120 includes a serial, differential interconnect architecture that is compliant with different interconnect standards. Interconnect protocols and features discussed below may be utilized to implement the links 120 coupling the set of components introduced here in FIG. 1.

Memory 106 includes any memory device, such as random access memory (RAM), non-volatile (NV) memory, or other memory accessible by devices in system 100. Memory 106 is coupled to SoC fabric 104 through a link 120, such as a memory interface, for example. Examples of a memory interface include a double-data rate (DDR) memory interface, a dual-channel DDR memory interface, a low power DDR (LPDDR), a dynamic RAM (DRAM) memory interface, or other types of memory interfaces.

The SoC fabric 104 is an interconnect infrastructure within a SoC design. It encompasses a network of wires, buses, and interconnects that facilitate communication and data transfer between various components and subsystems integrated on a single chip. The SoC fabric 104 serves as the backbone for connecting different functional blocks, such as the central processing unit (CPU) cores, memory controllers, input/output interfaces, graphics processors, accelerators, and other Intellectual Property (IP) blocks. It enables these components to communicate, share data, and work together to perform the desired tasks efficiently. The SoC fabric 104 is responsible for managing data flow, routing signals, and maintaining the necessary data paths between different components. It ensures that data is transmitted accurately and with low latency, while also optimizing power consumption and overall performance.

Although not shown, the SoC fabric 104 may be coupled to off-die devices. Input/Output (I/O) modules, also referred to as interfaces or ports, may implement a layered protocol stack to provide communication between SoC fabric 104 and one or more semiconductor devices implemented on other semiconductor dies in a semiconductor package.

The SoC 118 may further include one or more accelerators 108. An accelerator is a separate architectural substructure that is architected using a different set of objectives than the base processor, where these objectives are derived from the needs of a special class of applications. Examples of accelerators include a graphics accelerator to enhance graphics rendering capability, a cryptographic accelerator to help with encryption or decryption, a web accelerator to improve web applications, a hypertext preprocessor (PHP) accelerator to assist in web development, and so forth.

The SoC 118 may include other semiconductor devices or components to implement various compute or communications functions, such as a radio-frequency circuit 110, a modem 112, an optical device 114, an analog device 116, and so forth. Embodiments are not limited in the type or number of semiconductor devices implemented for the SoC 118.

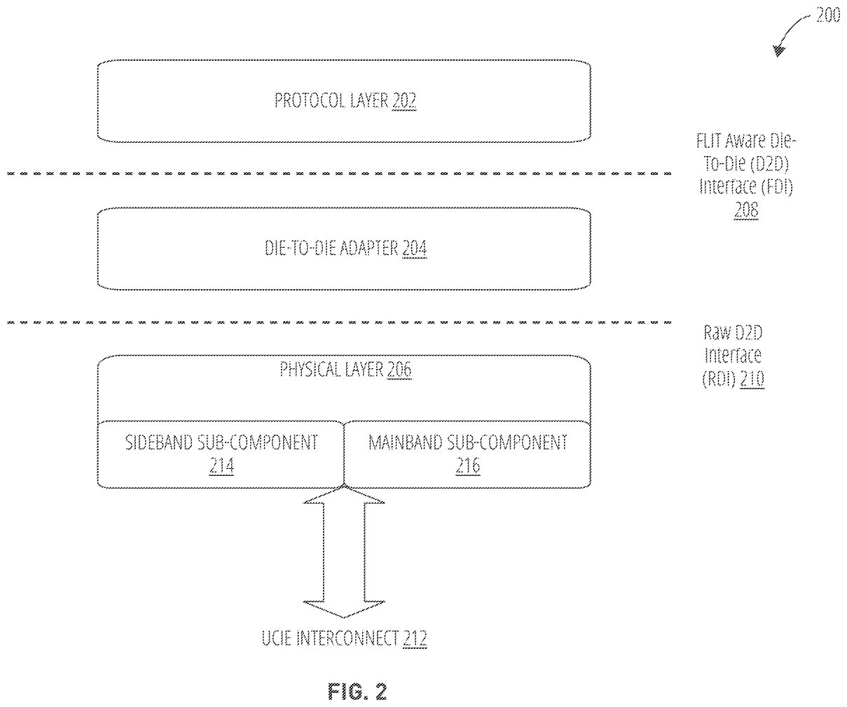

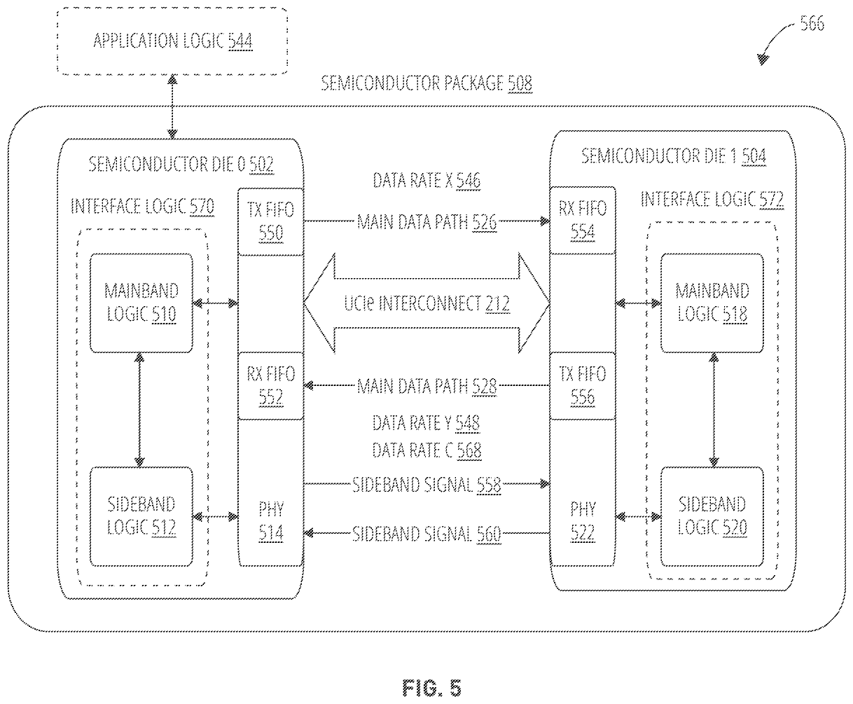

FIG. 2 illustrates a UCIe interconnect stack 200. In various embodiments, the SoC 118 may implement a UCIe interconnect 212, as defined by the UCIe Specification. The SoC 118 may use the UCIe interconnect 212 to communicate with other semiconductor dies within a same semiconductor package, as described with reference to FIG. 5.

In general, UCIe is an open industry standard interconnect offering high-bandwidth, low-latency, power-efficient, and cost-effective on-package connectivity between chiplets. The UCIe Specification defines a ubiquitous interconnect at the package level and covers the die-to-die (D2D) input/output (I/O) physical layer, D2D protocols, and software stack which leverage the well-established Peripheral Component Interconnect Express (PCI Express® or PCIe®) and Compute Express Link™ (CXL™) industry standards.

The UCIe Specification details the complete standardized D2D interconnect with physical layer, protocol stack, software model, and compliance testing that will enable end users to easily mix and match chiplet components from a multi-vendor ecosystem for System-on-Chip (SoC) construction, including customized SoC. The physical layer supports up to 32 gigatransfers per second (GT/s) with 16 to 64 lanes and uses a 256 byte Flow Control Unit (FCU) for data, similar to PCIe 6.0. The protocol layer is based on Compute Express Link with CXL.io (PCIe), CXL.mem and CXL.cache protocols. Various on-die interconnect technologies are defined, like organic substrate for a “standard” 2D package, or embedded silicon bridge (EMIB), silicon interposer, and fanout embedded bridge for “advanced” 2.5D/3D packages. Physical specifications are based on the Advanced Interface Bus (AIB) as defined by Intel® Corporation, headquartered in Santa Clara, California.

UCIe supports different data rates, widths, bump-pitches, and channel reach to ensure the widest interoperability feasible. It defines a sideband interface for ease of design and validation. The unit of construction of the interconnect is a cluster which comprises of N single-ended, unidirectional, full-duplex data lanes (where N=16 for standard package and 64 for advanced package), one single-ended lane for valid, one lane for tracking, a differential forwarded clock per direction, and 2 lanes per direction for sideband (e.g., single-ended, one 1200 MHz clock and one data). The advanced package supports spare lanes to handle faulty lanes (e.g., including clock, valid, sideband, etc.) where as the standard package supports width degradation to handle failures. Multiple clusters can be aggregated to deliver more performance per link.

UCIe is a layered protocol as represented by a UCIe interconnect stack 200. The UCIe interconnect stack 200 may comprise a protocol layer 202, a die-to-die adapter 204, and a physical layer 206.

The physical layer 206 may be coupled to a UCIe interconnect 212. The physical layer 206 is responsible for the electrical signaling, clocking, link training, lane repair, lane reversal, scrambling/descrambling, sideband initialization and transfers, analog front end (AFE), clock forwarding, and other physical layer operations. UCIe's main data path on the physical bumps is organized as a group of Lanes called a Module. A Module forms the atomic granularity for the structural design implementation of UCIe's analog front end (AFE). The number of Lanes per Module for Standard and Advanced package is specified in Chapter 4.0 of the UCIe Specification. A given instance of protocol layer 202 or die-to-die adapter 204 can send data over multiple modules where bandwidth scaling is required.

The physical layer 206 of UCIe comprises of two connections, denoted as a sideband sub-component 214 and a mainband sub-component 216.

The sideband sub-component 214 forms a connection used for parameter exchanges, register accesses for debug/compliance and coordination with remote partner for link training and management. It comprises a forwarded clock pin and a data pin in each direction. In one embodiment, the clock is fixed at 800 megahertz (MHz) regardless of the main data path speed. The sideband logic for UCIe's physical layer 206 should be on auxiliary power and an “always on” domain. Each module has its own set of sideband pins. For the Advanced Package option, a redundant pair of clock and data pins in each direction is provided for repair.

The mainband sub-component 216 forms a connection constitutes the main data path of UCIe. It consists of a forwarded clock, a data valid pin, and N Lanes of data per module. For the Advanced Package option, N=64 (also referred to as x64) and overall four extra pins for lane repair are provided in the bump map. For the Standard Package option, N=16 (also referred to as x16) and no extra pins for repair are provided.

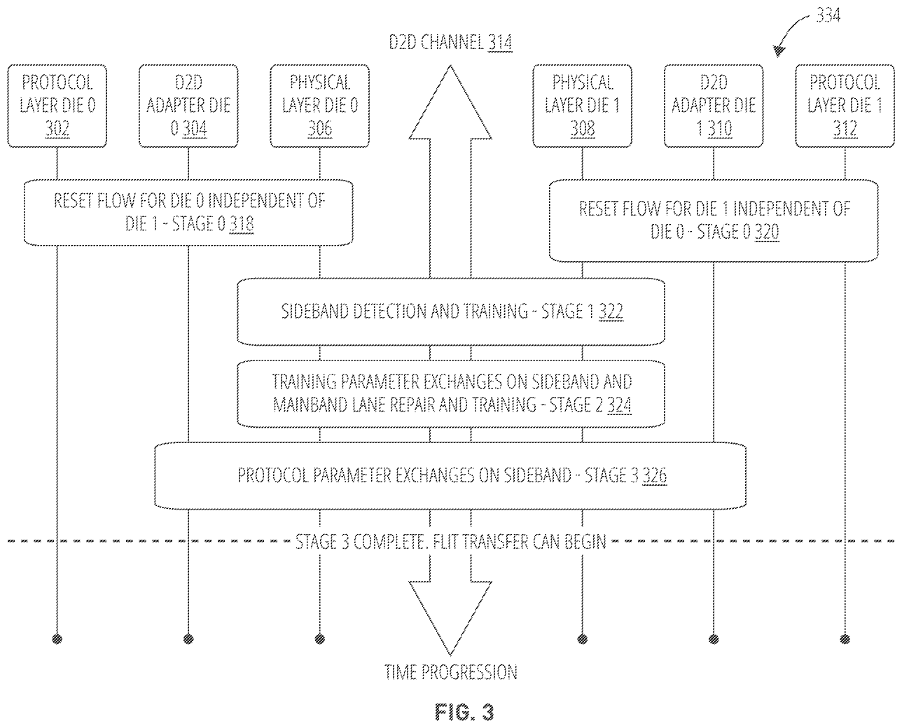

A Logical Physical Layer (PHY) coordinates the different functions and their relative sequencing for proper link bring up and management (for example, sideband transfers, mainband training and repair etc.). The Logical PHY comprehends the following functions: Link initialization, training and power management states; Byte to Lane mapping for data transmission over Lanes; Interconnect redundancy remapping (when required); Transmitting and receiving sideband messages; Scrambling and training pattern generation; Lane reversal; and Width degradation (when applicable). An example of link initialization operations are described with reference to FIG. 3.

Information may be passed between the physical layer 206 and the die-to-die adapter 204 over a raw D2D interface (RDI) 210. The die-to-die adapter 204 provides link state management and parameter negotiation for chiplets and semiconductor dies, such as the SoC 118, for example. It optionally guarantees reliable delivery of data through its cyclic redundancy check (CRC) and link level retry mechanism. When multiple protocols are supported, it defines the underlying arbitration mechanism. A 256-byte flow control unit (FCU) level interface transfer (FLIT) defines the underlying transfer mechanism when the adapter is responsible for reliable transfer. Information may be passed between the die-to-die adapter 204 and the protocol layer 202 over a FLIT aware D2D interface (FDI) 208.

UCIe maps PCIe and CXL protocols natively as those are widely deployed at the board level across all segments of compute. This is done to ensure seamless interoperability by leveraging the existing ecosystem. With PCIe and CXL, SoC construction, link management, and security solutions that are already deployed can be leveraged to UCIe. The usage models addressed are also comprehensive: data transfer using direct memory access, software discovery, error handling, etc., are addressed with PCIe/CXL.io; the memory use cases are handled through CXL.mem; and caching requirements for applications such as accelerators are addressed with CXL.cache. UCIe also defines a “streaming protocol” which can be used to map any other protocol. Further, the UCIe consortium can innovate on protocols in the future optimized for chiplets and semiconductor dies as usage models evolve in the future.

Although the UCIe interconnect 212 is designed to handle communications between chiplets, which are specialized integrated circuits (ICs), it can be extended to manage communications between any semiconductor dies, such as the SoC 118 and one or more memory ICs, referred to as memory chips. The SoC 118 and the memory chips are implemented as separate semiconductor dies on a same semiconductor package. The SoC 118 and the memory chips each implement UCIe interfaces and associated interface logic to allow the SoC 118 and the memory chips to communicate standard memory signals as UCIe signals transported over the UCIe interconnect 212. For example, the memory controller 122 of the SoC 118 may send read or write commands and data for an on-package memory unit using a standard memory interface and associated memory signals. Similarly, the on-package memory unit may receive the memory signals, and send a response to the memory controller 122 using a standard memory interface and associated memory signals. In-between, the UCIe interfaces and associated interface logic maps the memory signals to UCIe signals for transport over the UCIe interconnect 212, and the UCIe signals back to memory signals for communication to the memory controller 122 or the memory units. This allows a unified solution to scale on-package memory to support various applications ranging from applications suitable for hand-held computers to HPC type applications.

FIG. 3 illustrates a link initialization logic flow 334 for the mainband sub-component 216. The link initialization logic flow 334 comprises four stages before protocol Flit transfer can begin on a mainband channel of the UCIe interconnect 212. An example of the link initialization logic flow 334 and corresponding operations are described in Section 3.2 of the UCIe Specification.

The link initialization logic flow 334 shows the high level steps involved in the link initialization flow for a D2D channel 314 of the UCIe interconnect 212 over time. Stage 0 is die-specific and happens independently for each die; the corresponding boxes in FIG. 3 are of different sizes to denote that different die can take different amounts of time to finish Stage 0. Stage 1 involves sideband detection and training. Stage 2 involves mainband training and repair. Stage 3 involves parameter exchanges, such as configuration parameters, between die-to-die adapters 204 to negotiate the protocol and Flit formats.

As depicted in FIG. 3, a protocol layer die 0 302, a D2D adapter die 0 304 and a physical layer die 0 306 performs stage 0 318. Stage 0 318 performs a reset flow for die 0 independent of die 1. Meanwhile, a physical layer die 1 308, a D2D adapter die 1 310 and a protocol layer die 1 312 also performs stage 0 320. Stage 0 320 performs a reset flow for die 1 independent of die 0. Once stage 0 318 and stage 0 320 are complete, the physical layer die 0 306 and the physical layer die 1 308 performs stage 1 322. Stage 1 322 performs sideband detection and training operations.

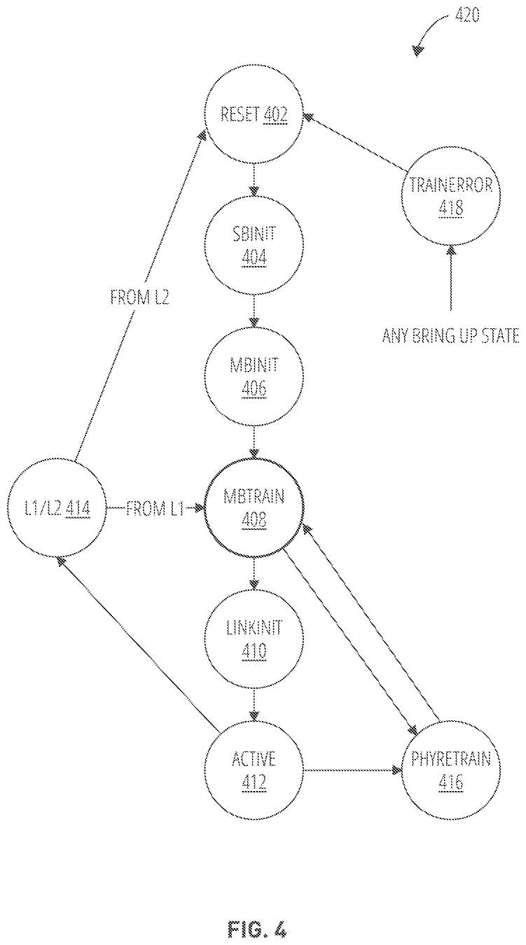

Once stage 1 322 is complete, the physical layer die 0 306 and the physical layer die 1 308 performs stage 2 324. Stage 2 324 performs training parameter exchanges on a sideband channel and mainband lane repair and training operations. During stage 2 324, training parameter exchanges may include exchanging parameters for mainband initialization and training, including establishing and negotiating data rates of die 0 and die 1. An example of mainband initialization and training is described with reference to FIG. 4. Stage 2 324 is complete when the RDI 210 state machine moves to Active State. The initialization flow on RDI 210 to transition the state from Reset to Active is described in section 8.1.6 of the UCIe Specification.

Once Stage 2 324 is complete, the D2D adapters must follow a sequence of steps in order to determine local capabilities, complete parameter exchanges, and bring FDI state machine to Active. For example, the D2D adapter die 0 304 and the D2D adapter die 1 310 perform stage 3 326. Stage 3 326 performs protocol parameter exchanges on the sideband channel of the D2D channel 314.

FIG. 4 illustrates an initialization logic flow 420 suitable for stage 2 324. UCIe has a hierarchical approach to link state management in order to have well-defined functionality partitioning between the different layers and also enabling common state transitions or sequencing at FDI 208 and RDI 210.

The initialization logic flow 420 shows a high-level initialization flow with different states. A high-level description of state definitions for initialization is shown in TABLE 1, as follows.

TABLE 1

| State | Description |
|---|---|
| RESET | This is the state following primary reset or exit from TRAINERROR |
| SBINIT | Side band initialization state where the side band is detected, repaired (when |
| | applicable) and out of reset message is transmitted |
| MBINIT | Following sideband initialization, Main band (MB) is initialized at the lowest |
| | speed. Both dies perform on die calibration followed by interconnect repair |
| | (when applicable) |
| MBTRAIN | Main band (Data, Clock and Valid signals) speed of operation is set to the |
| | highest negotiated data rate. Die-to-Die training of main band is performed to |
| | center the clock with respect to Data. |
| LINKINIT | This state is used to exchange Adapter and Link management messages |
| ACTIVE | This is the state in which transactions are sent and received |
| L1/L2 | Power Management state |
| PHYRETRAIN | This state is used to begin the retrain flow for the Link during runtime |
| TRAINERROR | State is entered when a fatal or non-fatal event occurs at any point during Link |
| | Training or operation. |

The initialization logic flow 420 depicts a flow between different states denoted as reset 402, SBINIT 404, MBINIT 406, MBTRAIN 408, LINKINIT 410, ACTIVE 412, L1/L2 414, PHYRETRAIN 416 and TRAINERROR 418. Each of these states correspond to descriptions as provided in the UCIe Specification.

In particular, the UCIe Specification defines the state MBINIT 406. In this state, the mainband interface is initialized and repaired or degraded (when applicable). The data rate on the mainband is set to the lowest supported data rate (4 GT/s). For Advanced Package interface interconnect repair may be needed. Sub-state in MBINIT allows detection and repair of data, clock, track and valid Lanes. For Standard Package interface, where no Lane repair is needed. Sub-states is used to check functionality at lowest data rate and width degrade if needed.

The UCIe Specification also defines the state MBTRAIN 408. The MBTRAIN 408 state is used to setup operational speed and perform clock to data centering. At higher speeds, additional calibrations like Rx clock correction, transmit (Tx) and receive (Rx) deskew may be needed to ensure link performance. MBTRAIN 408 uses sub-states to perform all the required calibration and training. UCIe Modules must enter each sub-state and the exit from each sub-state is coordinated between UCIe Module Partners through sideband handshakes. If a particular action within a sub-state is not needed, the UCIe Module is permitted to exit the sub-state through the relevant sideband handshake without performing the described operations in that sub-state.

In the state MBINIT 406, a MBINIT.PARAM is used to perform exchange of parameters required to setup the maximum negotiated speed and other PHY settings. Mainband Transmitters remain tri-stated and mainband Receivers are permitted to be disabled. The following parameters are exchanged with a UCIe Module (e.g., die 0) and a UCIe Module Partner (e.g., die 1).

1. “Voltage swing”: The five bit value indicates the Transmitter voltage swing to the UCIe Module Partner. The UCIe Module Partner must use this value and its Receiver termination information to set the reference voltage (Vref) for its Receivers. The corresponding bits in {MBINIT.PARAM configuration resp} are reserved.

2. “Maximum Data Rate”: The four bit value indicates the Maximum supported Data rate to the UCIe Module Partner. This value must take into consideration all the required features at the data rate (bit error rate (BER), cyclic redundancy check (CRC), retry, quadrature clock phase support, etc.). The UCIe Module Partner must compare this value with its supported maximum data rate and must respond with the maximum common data rate encoding in {MBINIT.PARAM configuration resp}. For example, a UCIe Module is 8 GT/s capable while the UCIe Module Partner advertises 16 GT/s, the UCIe Module must pick 8 GT/s and send it back in response.

3. “Clock Mode”: The one bit value indicates the UCIe Module's request to UCIe Module Partner for a strobe or continuous clock. The UCIe Module Partner must use this information to setup the clock mode on its clock Transmitter. {MBINIT.PARAM configuration resp} must reflect the same value.

4. “Clock Phase”: The one bit value indicates the UCIe Module's request to UCIe Module Partner for the Clock Phase support on UCIe Module's forwarded clock. This should only be set 1b if the maximum data rate advertised is permitted to do so (refer to Table 35 of the UCIe Specification). The corresponding bit in {MBINIT.PARAM configuration resp} must be set to 1b if this was requested and the operational data rate allows it.

5. “Module ID”: The UCIe Module sends its “Module ID”. This can be used by the UCIe Module Partner if in a multi-module configuration for Byte mapping, Module enable disable information etc. The corresponding bits in {MBINIT.PARAM configuration resp} are reserved.

6. “UCIe-A x32”: This bit is set to 1b when APMW bit in DVSEC UCIe Link Capability register (see Section 7.5.1.4) is set to 1b (OR) ‘Force x32 width mode in x64 Module’ in the PHY Control register (see Section 7.5.3.23) is set; otherwise, the bit is set to 0b. If a x64 Advanced Package module supports width reduction to interoperate with a x32 Advanced Package Module, it uses this information from its link partner to condition the results during MBINIT.REVERSALMB. The corresponding bits in {MBINIT.PARAM configuration resp} are reserved.

Following is an example sequence for parameter exchange: (1) the UCIe Module sends sideband message {MBINIT.PARAM configuration req} to exchange parameters with the UCIe Module Partner; and (2) once {MBINIT.PARAM configuration req} is received, the UCIe Module Partner resolves and responds with {MBINIT.PARAM configuration resp} sideband message.

As indicated above, the UCIe Module sends a parameter for a maximum supported data rate to the UCIe Module Partner. The UCIe Module Partner compares this value with its supported maximum data rate and must respond with the maximum common data rate encoding in {MBINIT.PARAM configuration resp}. For example, a UCIe Module is 8 GT/s capable while the UCIe Module Partner advertises 16 GT/s, the UCIe Module must pick 8 GT/s and send it back in response. The maximum common data rate is an example of a symmetric data rate between the UCIe Module and the UCIe Module Partner.

Embodiments implement techniques that allow the UCIe Module and the UCIe Module Partner to each operate at an asymmetric data rate, where the asymmetric data rate comprises each of their own maximum possible data rates instead of using a negotiated data rate. The UCIe interconnect 212 may be trained to use the symmetric data rate or the asymmetric data rate in response to a signal that enables a given transport mode, where the transport mode uses the symmetric data rate or the asymmetric data rate. The transport mode may be set by an application that is on-die or off-die. For example, application logic may generate an application signal to enable a given transport mode. The UCIe Module which supports this feature will initially negotiate link speed but when the traffic starts it will have the flexibility to run at a higher rate compared to the negotiated rate.

To this end, embodiments add a novel exchange of parameters between the UCIe Module and the UCIe Module Partner to negotiate and establish an asymmetric data rate. Embodiments may use an existing parameter, such as MBINIT.PARAM configuration request and/or MBINIT.PARAM configuration response, or a new defined parameter, such as MBINIT.PARAM.AS, for example. An example of a representative system 566 to implement modified versions of MBINIT 406 and/or MBTRAIN 408 to initialize, train and utilize asymmetric data rates for the mainband of the UCIe interconnect 212 is described with reference to FIG. 5.

FIG. 5 illustrates a system 566 that provides an example for implementing the embodiments as described herein. System 566 includes a semiconductor package 508. The semiconductor package 508 comprises a semiconductor die 0 502 and a semiconductor die 1 504 capable of communicating control and data signals over the UCIe interconnect 212.

As depicted in FIG. 5, the semiconductor die 0 502 comprises interface logic 570, such as mainband logic 510 and sideband logic 512, coupled to a PHY 514. The mainband logic 510 and the sideband logic 512 may comprise examples of the logic for die-to-die adapter 204 and the D2D adapter die 0 304 to perform link initialization and training, such as described with the link initialization logic flow 334 and/or the initialization logic flow 420. The PHY 514 comprises one or more of a transmit FIFO 550 and a receive FIFO 552. A First-In, First-Out (FIFO) is used for organizing and manipulating data in a specific order using a data structure called a FIFO queue. In a FIFO queue, new elements are added to the back (also known as the tail) of the queue, and removal of elements takes place from the front (also known as the head) of the queue. This ensures that the oldest element in the queue is always the first one to be removed. In one embodiment, for example, each side of the UCIe interconnect 212 is permitted to instantiate clock crossing FIFOs internally if needed, as long as it does not violate the requirements at the interface itself.

The semiconductor die 1 504 implements similar structures as the semiconductor die 0 502. The semiconductor die 1 504 comprises interface logic 572, such as mainband logic 518 and sideband logic 520, coupled to a PHY 522. The PHY 522 includes one or more of a receive FIFO 554 and a transmit FIFO 556.

The semiconductor die 0 502 and the semiconductor die 1 504 communicate UCIe signals to transport information between each other via one or more main data paths, such as main data path 526 and main data path 528, for example. The main data path 526 and the main data path 528 use one or more lanes and modules as previously described. The main data path 526 transports information from the transmit FIFO 550 of the semiconductor die 0 502 to the receive FIFO 554 of the semiconductor die 1 504. The main data path 528 transports information from the transmit FIFO 556 of the semiconductor die 1 504 to the receive FIFO 552 of the semiconductor die 0 502. Although a single main data path 526 and main data path 528 are depicted in FIG. 5, it may be appreciated that multiple main data paths 526 and multiple main data paths 528 may be implemented for bandwidth scaling using corresponding modules. It is also worthy to note that from the perspective of semiconductor die 0 502, the main data path 526 is used to transmit information to the semiconductor die 1 504, and is sometimes referred to as a transmit channel for the semiconductor die 0 502. However, from the perspective of semiconductor die 1 504, the main data path 526 is used to receive information from the semiconductor die 0 502, and is sometimes referred to as a receive channel for the semiconductor die 1 504. The same concept holds true for the main data path 528. Consequently, the main data path 526 and the main data path 528 may be considered transmit channels or receive channels depending on whether the semiconductor die 0 502 and the semiconductor die 1 504 are transmitting information or receiving information.

The semiconductor die 0 502 and the semiconductor die 1 504 may also exchange sideband information transported as sideband signal 558 and/or sideband signal 560 over one or more transmit channels or receive channels of the UCIe interconnect 212. The sideband information may include configuration parameters for the semiconductor die 0 502 and the semiconductor die 1 504. The mainband logic 510, mainband logic 518, sideband logic 512, and/or sideband logic 520 may use the configuration parameters for link initialization, link training, link transport, and other operations as previously described.

In particular, the sideband information may be used to initialize, train, and negotiate a symmetric data rate and/or an asymmetric data rate for a mainband of the UCIe interconnect 212 as represented by the main data path 526 and the main data path 528.

As previously described, the sideband logic 512 of the semiconductor die 0 502 may negotiate a symmetric data rate for the main data path 526 and the main data path 528. In one embodiment, the symmetric data rate may comprise a four bit value indicating the maximum supported data rate X 546 from the semiconductor die 0 502 to the semiconductor die 1 504. This value takes into consideration all the required features at the data rate (bit error rate (BER), cyclic redundancy check (CRC), retry, quadrature clock phase support, etc.). The sideband logic 520 of the semiconductor die 1 504 compares this value with its supported maximum data rate Y 548 and it responds with the maximum common data rate C 568 encoding in {MBINIT.PARAM configuration resp}. For example, assume the semiconductor die 0 502 is 16 GT/s capable while the semiconductor die 1 504 advertises 12 GT/s, the semiconductor die 1 504 picks 12 GT/s for both the main data path 526 and the main data path 528, and sends the symmetric data rate back to the semiconductor die 0 502 in response.

Additionally or alternatively, the sideband logic 512 of the semiconductor die 0 502 may negotiate an asymmetric data rate for the main data path 526 and the main data path 528. In one embodiment, the symmetric data rate may comprise a four bit value indicating the maximum supported data rate from the semiconductor die 0 502 to the semiconductor die 1 504. This value takes into consideration all the required features at the data rate (bit error rate (BER), cyclic redundancy check (CRC), retry, quadrature clock phase support, etc.). The sideband logic 520 of the semiconductor die 1 504 compares this value with its supported maximum data rate and it responds with its maximum data rate encoding in {MBINIT.PARAM configuration resp}. For example, assume the semiconductor die 0 502 is 16 GT/s capable while the semiconductor die 1 504 advertises 12 GT/s, the semiconductor die 1 504 picks 16 GT/s for the main data path 526 and 12 GT/s for the main data path 528, and sends the asymmetric data rate back to the semiconductor die 0 502 in response.

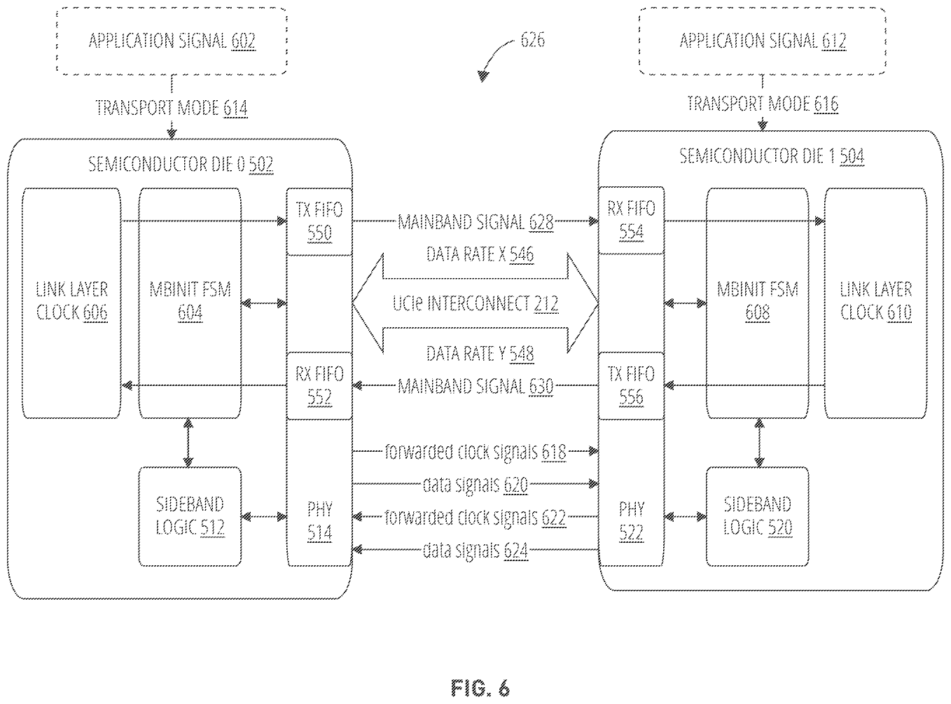

FIG. 6 illustrates a system 626. The system 626 provides a more detailed view of the semiconductor die 0 502 and the semiconductor die 1 504 introduced in system 566 of FIG. 5.

More specifically, the semiconductor die 0 502 includes a mainband initialization (MBINIT) finite state machine (FSM) referred to as MBINIT FSM 604 coupled to the sideband logic 512 and a link layer clock 606. The MBINIT FSM 604 implements a state machine for the mainband logic 510 to perform mainband initialization operations as previously described. The link layer clock 606 is a clocking mechanism, such as a hardware clock or software clock, for link layer operations implemented by the semiconductor die 0 502. UCIe interconnect 212 supports multiple protocols (e.g., PCIe, CXL, Streaming, and a raw format that can be used to map any protocol of choice as long as both ends support it) on top of a common physical and link layer. In one embodiment, the UCIe interconnect 212 allows for a single UCIe link to be shared by multiple protocol stacks.

Similarly, the semiconductor die 1 504 includes a mainband initialization (MBINIT) finite state machine (FSM) referred to as MBINIT FSM 608 coupled to the sideband logic 520 and a link layer clock 610. The MBINIT FSM 604 implements a state machine for the mainband logic 518 to perform mainband initialization operations as previously described. The link layer clock 610 is a clocking mechanism, such as a hardware clock or software clock, for link layer operations implemented by the semiconductor die 0 502.

As previously described with reference to FIG. 5, the PHY 514 of the semiconductor die 0 502 and the PHY 522 of the semiconductor die 1 504 may exchange information over the main data path 526 and the main data path 528. In one embodiment, the PHY 514 of the semiconductor die 0 502 may send a mainband signal 628 from the transmit FIFO 550 over a transmit channel of the main data path 526 to the receive FIFO 554 over the main data path 526. The PHY 522 of the semiconductor die 1 504 may receive the mainband signal 628 from the transmit FIFO 550 over a receive channel of the main data path 526 by the receive FIFO 554 over the main data path 526. In one embodiment, the PHY 522 of the semiconductor die 1 504 may send a mainband signal 630 from the transmit FIFO 556 over a transmit channel of the main data path 528 to the receive FIFO 552 over the main data path 528. The PHY 514 of the semiconductor die 0 502 may receive the mainband signal 630 from the transmit FIFO 556 over a receive channel of the main data path 528 by the receive FIFO 552 over the main data path 528.

As previously described with reference to FIG. 5, the PHY 514 of the semiconductor die 0 502 and the PHY 522 of the semiconductor die 1 504 may also exchange sideband signal 558 and sideband signal 560 to transport sideband information, such as configuration parameters, for example. In addition, the PHY 514 and the PHY 522 may exchange clock information via forwarded clock signals 618 and forwarded clock signals 622, and data via data signals 620 and data signals 624, as defined by the UCIe Specification. In one embodiment, the forwarded clock signals 618 may comprise clock information from the link layer clock 606 of the semiconductor die 0 502. In one embodiment, the forwarded clock signals 622 may comprise clock information from the link layer clock 610 of the semiconductor die 1 504.

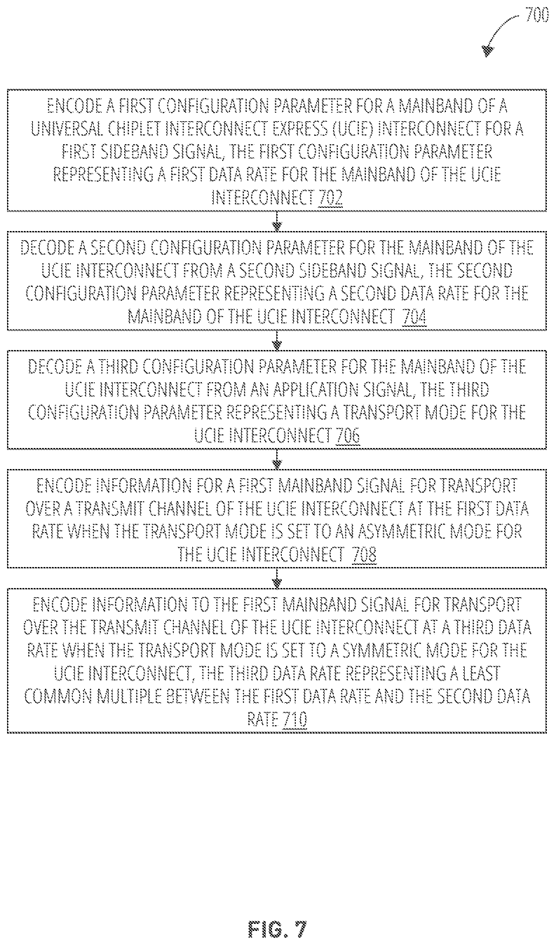

Operations for the semiconductor die 0 502 and/or the semiconductor die 1 504 are further described with reference to FIG. 7.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

FIG. 7 illustrates an embodiment of a logic flow 700. The logic flow 700 may be representative of some or all of the operations executed by one or more embodiments described herein. For example, the logic flow 700 may include some or all of the operations performed by devices or entities described herein. More particularly, the logic flow 700 illustrates an example where the semiconductor die 0 502 and the semiconductor die 1 504 communicating UCIe signals over a sideband channel and/or a mainband channel of the UCIe interconnect 212.

In block 702, logic flow 700 encodes a first configuration parameter for a mainband of a universal chiplet interconnect express (UCIe) interconnect for a first sideband signal, the first configuration parameter representing a first data rate for the mainband of the UCIe interconnect. In block 704, logic flow 700 decodes a second configuration parameter for the mainband of the UCIe interconnect from a second sideband signal, the second configuration parameter representing a second data rate for the mainband of the UCIe interconnect. In block 706, logic flow 700 decodes a third configuration parameter for the mainband of the UCIe interconnect from an application signal, the third configuration parameter representing a transport mode for the UCIe interconnect. In block 708, logic flow 700 encodes information for a first mainband signal for transport over a transmit channel of the UCIe interconnect at the first data rate when the transport mode is set to an asymmetric mode for the UCIe interconnect. In block 710, logic flow 700 encodes information to the first mainband signal for transport over the transmit channel of the UCIe interconnect at a third data rate when the transport mode is set to a symmetric mode for the UCIe interconnect, the third data rate representing a least common multiple between the first data rate and the second data rate.

By way of example, with reference to semiconductor die 0 502 and/or semiconductor die 1 504, the sideband logic 512 of the semiconductor die 0 502 encodes a first configuration parameter for a main data path 526 of the UCIe interconnect 212 in a first sideband signal 558. The first configuration parameter represents a first data rate X 546 for the mainband of the UCIe interconnect 212, where X represents any positive integer. The sideband logic 512 also decodes a second configuration parameter for the main data path 528 of the UCIe interconnect 212 from a second sideband signal 558. The second configuration parameter represents a second data rate Y 548 for the main data path 528 of the UCIe interconnect 212, where Y represents any positive integer.

In one embodiment, the first data rate X 546 may be the same or nearly the same as the second data rate Y 548 (e.g., X=Y). In one embodiment, the first data rate may be different from the second data rate. For example, the first data rate X 546 may be higher than the second data rate Y 548 (e.g., X>Y) or the first data rate X 546 may be lower than the second data rate Y 548 (e.g., X<Y), and vice-versa (e.g., Y>X or Y<X).

In one embodiment, the first data rate X 546 for the main data path 526 of the UCIe interconnect 212 represents a maximum transmit data rate and/or a maximum receive data rate of semiconductor die 0 502. Similarly, the second data rate Y 548 for the main data path 528 of the UCIe interconnect 212 represents a maximum transmit data rate and/or a maximum receive data rate of semiconductor die 1 504.

The sideband logic 512 decodes a third configuration parameter for the main data path 526 and main data path 528 of the UCIe interconnect 212 from an application signal 602. For example, application logic 544 may be implemented by an on-die or off-die application that uses the transport services of the UCIe interconnect 212. The application may require different data rates to transmit and receive data. For example, assume the application uses a memory controller implemented by the semiconductor die 0 502 to read and write data to a memory unit implemented by the semiconductor die 1 504. The read operations may occur more frequently than the write operations, or vice-versa. In such cases, the application may encode a transport mode 614 and a transport mode 616 in an application signal 602 and application signal 612, respectively, to indicate a need for an asymmetric data rate.

The mainband logic 510 encodes information for a first mainband signal 628 for transport over a transmit channel of the main data path 526 of the UCIe interconnect 212 at the first data rate X 546 when the transport mode 614 is set to an asymmetric mode for the UCIe interconnect 212. The mainband logic 510 may also decode information from a second mainband signal 630 from a receive channel of the UCIe interconnect 212 at the second data rate Y 548 when the transport mode is set to the asymmetric mode for the UCIe interconnect. In one embodiment, for example, the mainband logic 510 may decode information from the second mainband signal 630 using a third sideband signal 560, where the third sideband signal 560 includes one or more forwarded clock signals 622 from the link layer clock 610.

Additionally or alternatively, the mainband logic 510 encodes information to the first mainband signal 628 for transport over the main data path 526 of the UCIe interconnect 212 at a third data rate C 568 when the transport mode 614 is set to a symmetric mode for the UCIe interconnect 212, where Z represents any positive integer. In one embodiment, the third data rate C 568 represents a least common multiple between the first data rate X 546 and the second data rate Y 548.

The above examples depict operations from the perspective of the semiconductor die 0 502. The same examples may be reversed to depict the same operations from the perspective of the semiconductor die 1 504. In one embodiment, the UCIe interconnect 212 transports signals between the semiconductor die 0 502 and the semiconductor die 1 504 when implemented in a single semiconductor package 508. In one embodiment, the UCIe interconnect 212 transports signals between the semiconductor die 0 502 and the semiconductor die 1 504 when implemented in different semiconductor packages 508 or when mounted on a common substrate, such as a printed circuit board (PCB), for example.

More particularly, during the UCIe interconnect 212 initialization, a speed will be negotiated between the semiconductor die 0 502 and the semiconductor die 1 504 wherein both dies exchange the maximum data rate value at which each of them can operate. Based on these values both dies will agree to operate on a least common multiplier data rate value. The current UCIe Specification does not mention an asymmetric data rate option where the semiconductor die 0 502 and semiconductor die 1 504 can operate on a different data rate based on individual capabilities. However, an asymmetric data rate option is possible since the RX FIFO is operating on the forwarded clock from the TX side.

Below are the different possible combinations based on a current version of the UCIe Specification which defines symmetric data rates. When the semiconductor die 0 502 and semiconductor die 1 504 have a common maximum frequency, they both agree to run at that value. When the semiconductor die 0 502 supports X Gbps and the semiconductor die 1 504 supports Y Gbps, where X>Y, then during negotiation, the semiconductor die 0 502 will negotiate with X′=Y. The semiconductor die 0 502 and the semiconductor die 1 504 then run at Y data rate. When the semiconductor die 0 502 supports X Gbps and the semiconductor die 1 504 supports Y Gbps, where X<Y, then during negotiation, the semiconductor die 1 504 will negotiate with Y′=X. The semiconductor die 0 502 and the semiconductor die 1 504 then run at X data rate.

Below are the different possible combinations based on a future version of the UCIe Specification which adopts asymmetric data rates. When the semiconductor die 0 502 and semiconductor die 1 504 have a common maximum frequency, they both agree to run at that value. When the semiconductor die 0 502 supports X Gbps and the semiconductor die 1 504 supports Y Gbps, where X>Y, then during negotiation, the semiconductor die 0 502 will negotiate with X′=Y. The semiconductor die 0 502 runs at X data rate and the semiconductor die 1 504 runs at Y data rate. When the semiconductor die 0 502 supports X Gbps and the semiconductor die 1 504 supports Y Gbps, where X<Y, then during negotiation, the semiconductor die 1 504 will negotiate with Y′=X. The semiconductor die 0 502 runs at X data rate and the semiconductor die 1 504 runs at Y data rate.

In a first case, assume PHY 514 of the semiconductor die 0 502 can run at a maximum of X data rate and PHY 522 of the semiconductor die 1 504 can run at a maximum of Y data rate, where X>Y. The PHY 514 and PHY 522 may negotiate a symmetric data rate of Y, and both dies then run at the Y data rate. Alternatively, the PHY 514 and PHY 522 may negotiate an asymmetric data rate, where the negotiated speed from PHY 522 will be Y and the negotiated speed from PHY 514 will be X. There is a data rate X′ that the PHY 514 will now be aware of, where X′=negotiated speed less than the actual PHY 514 speed. However, the PHY 514 does not run any part of its logic on X′, but rather all the logic in PHY 514 runs at X data rate. The PHY 514 transmission will run on a phase-locked loop (PLL) of the semiconductor die 0 502 and the PHY 522 reception will run on forwarded clock signals 618 from the sideband logic 512. Hence, even when this physical channel can run at Y data rate, it will continue to run at X data rate because of the forwarded clock signals 618.

The PHY 522 transmission will run on a PLL of the semiconductor die 1 504 and the PHY 514 reception will run on forwarded clock signals 622 from the semiconductor die 1 504. Hence, even if this physical channel can run at X data rate, it will continue to run at Y data rate because of forwarded clock signals 622.

Assume the link layer clock 606 is running at a Z data rate, where Z represents any positive integer. Further assume the case were Z>X>Y. The bottle neck in any communication system is typically the PHY layer. Previously, the PHY layer used to operate at a lower speed of the PHY layer of the 2 dies, that is the symmetric data rate. However, by enabling an asymmetric data rate, the PHY layers of the 2 dies can run at a highest data rate possible on its channel. The link can continue to run at a still higher data rate, such as when Z>>X>>Y. TABLE 2 provides some example values.

TABLE 2

| | Module | | Asymmetrical |
|---|---|---|---|
| Module PHY | Partner PHY | Symmetrical Data | Data Rate |
| Frequency in | Frequency in | Rate Negotiation | Negotiation |
| Gbps | Gbps | in Gbps | in Gbps |
| 4 | 4 | Agreed/ | Agreed/Negotiated = |
| | | Negotiated = 12 | X′ = 12 |
| 8 | 8 | Module will run at | Module will continue |
| | | 12 | to run at 16 |
| 12 | 12(Y) | Partner will run at | Partner will continue |
| | | 12 | to run at 12 |
| 16(X) | | | Z >> X >> Y |

In a second case, assume PHY 514 of the semiconductor die 0 502 can run at a maximum of X data rate and PHY 522 of the semiconductor die 1 504 can run at a maximum of Y data rate, where X<Y. The PHY 514 and PHY 522 may negotiate a symmetric data rate of X, and both dies then run at the X data rate. Alternatively, the PHY 514 and PHY 522 may negotiate an asymmetric data rate, where the negotiated speed from PHY 522 will be Y and the negotiated speed from PHY 514 will be X. There is a data rate Y′ that the PHY 522 will now be aware of, where Y′=negotiated speed less than the actual PHY 514 speed. However, the PHY 522 does not run any part of its logic on Y′, but rather all the logic in PHY 522 runs at Y data rate. The PHY 514 transmission will run on a PLL of the semiconductor die 0 502 and the PHY 522 reception will run on forwarded clock signals 618 from the sideband logic 512. Hence, even when this physical channel can run at Y data rate, it will continue to run at X data rate because of the forwarded clock signals 618.

The PHY 522 transmission will run on a PLL of the semiconductor die 1 504 and the PHY 514 reception will run on forwarded clock signals 622 from the semiconductor die 1 504. Hence, even if this physical channel can run at X data rate, it will continue to run at Y data rate because of forwarded clock signals 622.

Assume the link layer clock 606 is running at a Z data rate. Further assume the case were Z>Y>X. The bottle neck in any communication system is typically the PHY layer. Previously, the PHY layer used to operate at a lower speed of the PHY layer of the 2 dies, that is the symmetric data rate. However, by enabling an asymmetric data rate, the PHY layers of the 2 dies can run at a highest data rate possible on its channel. The link can continue to run at a still higher data rate, such as when Z>>Y>>X. TABLE 3 provides some example values.

TABLE 3

| | Partner PHY | | Asymmetrical |
|---|---|---|---|
| Module PHY | Module | Symmetrical Data | Data Rate |
| Frequency in | Frequency in | Rate Negotiation | Negotiation |
| Gbps | Gbps | in Gbps | in Gbps |
| 4 | 4 | Agreed/ | Agreed/Negotiated = |
| | | Negotiated = 12 | Y′ = 12 |
| 8 | 8 | Module will run at | Module will |
| | | 12 | continue to run at 12 |
| 12(X) | 12 | Partner will run at | Partner will continue |
| | | 12 | to run at 16 |
| | 16(Y) | | Z >> Y >> X |

Embodiments are not limited to these examples.

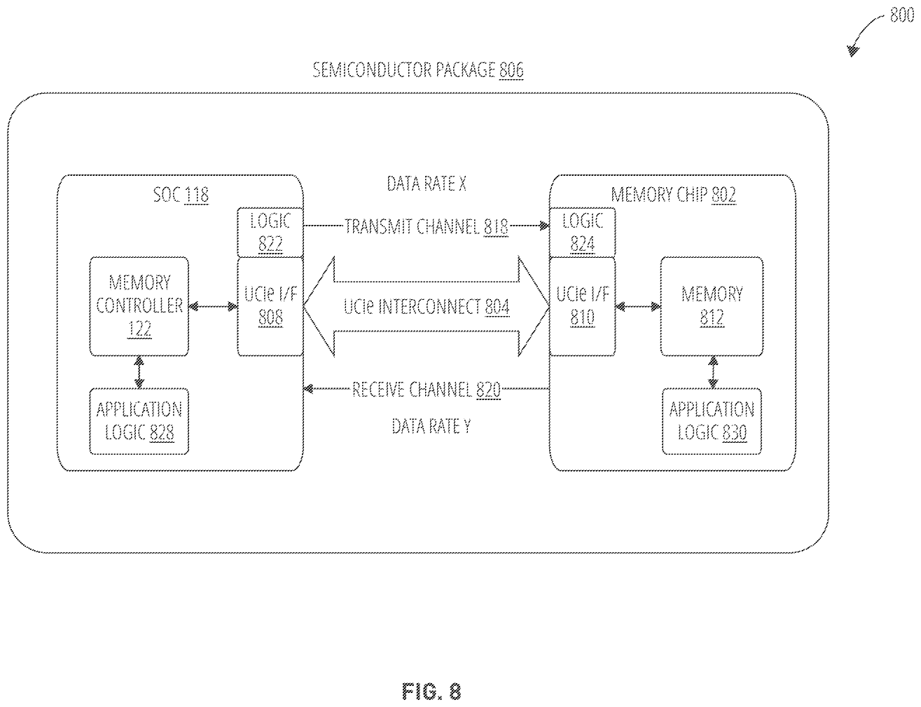

FIG. 8 illustrates a system 800. System 800 depicts a specific example of a pair of semiconductor dies similar to the semiconductor die 0 502 and the semiconductor die 1 504 implemented by the system 566 and/or the system 626. The example semiconductor dies may implement the symmetric data rate technique and the asymmetric data rate technique as described herein.

System 800 may comprise a SoC 118 and a memory chip 802 integrated on a single semiconductor package 806. The SoC 118 may exchange signals with the memory chip 802 over a UCIe interconnect 804. The SoC 118 and the memory chip 802 may implement UCIe interface 808 and UCIe interface 810, respectively. The SoC 118 and memory chip 802 may also implement interface logic 822 and interface logic 824, respectively. In one embodiment, the UCIe interface 808, the UCIe interface 810, the interface logic 822, the interface logic 824, and the UCIe interconnect 804 may be compliant with the UCIe Specification.

In various embodiments, operations for the UCIe interface 808 and the interface logic 822 mirror operations for the UCIe interface 810 and the interface logic 824, and vice-versa. Consequently, operations discussed with respect to the UCIe interface 808 and the interface logic 822 of the SoC 118 are the same or similar as those for the UCIe interface 810 and the interface logic 824 of the memory chip 802, and vice-versa.

In various embodiments, the memory controller 122 of the SoC 118 may communicate with a memory 812 of the memory chip 802 via the UCIe interconnect 804. In one embodiment, for example, the UCIe interface 808 and the UCIe interface 810 may each implement interface logic 822 and interface logic 824, respectively, to manage communications over the UCIe interconnect 804. Each of the interface logic 822 and the interface logic 824 manages transport of data over the UCIe interconnect 804 in a transmit mode and a receive mode.

From the perspective of the SoC 118, in the transmit mode, the UCIe interface 808 receives memory signals from the memory controller 122. The memory signals may comprise, for example, write or read commands represented as dynamic random access memory family interface (DFI) signals. The interface logic 822 decodes the DFI signals, and maps the memory signals to corresponding UCIe signals. The interface logic 822 encodes the UCIe signals for transmission over a transmit channel 818 of the UCIe interconnect 804.

From the perspective of the memory chip 802, in the receive mode, the UCIe interface 810 receives the UCIe signals from the transmit channel 818. The interface logic 824 decodes the UCIe signals, and maps the UCIe signals to corresponding memory signals, such as the DFI signals. The UCIe interface 810 sends the DFI signals to the memory 812. The memory 812 receives the DFI signals, and generates a response. For example, if the DFI signals represent a read request, the memory 812 retrieves the requested data, and sends the data as DFI signals back to the UCIe interface 810. In the transmit mode, the interface logic 824 decodes the DFI signals, and maps the memory signals to corresponding UCIe signals. The UCIe interface 810 sends the UCIe signals over the receive channel 820 of the UCIe interconnect 804 to the SoC 118.

Returning to the perspective of the SoC 118, in the receive mode, the UCIe interface 808 receives the UCIe signals from the receive channel 820 of the UCIe interconnect 804. The interface logic 822 decodes the UCIe signals, and maps the UCIe signals to memory signals, and encodes the memory signals as DFI signals for transmission to the memory controller 122.

In various embodiments, the memory signals are double data rate (DDR) memory signals or high bandwidth memory (HBM) memory signals. For example, the memory signals may comprise signals associate with a DDR memory interface, a dual-channel DDR memory interface, a LPDDR memory interface, a dynamic RAM (DRAM) memory interface, or other types of memory interfaces.

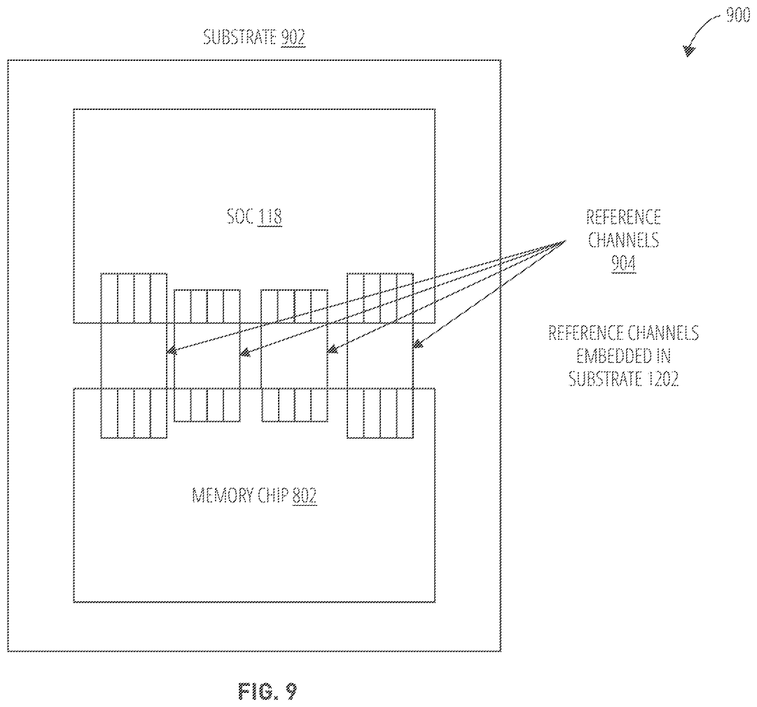

FIG. 9 illustrates a semiconductor package 900. The semiconductor package 900 includes the SoC 118 and the memory chip 802 assembled on a substrate 902. The SoC 118 and the memory chip 802 may communicate over a set of reference channels 904. In one embodiment, the reference channels 904 are embedded in the substrate 902. The reference channels 904 may be implemented as wire bonds, traces, a silicon bridge, interposer, and other communications media.

The semiconductor package 900 may have different physical configurations for semiconductor testing, with the different physical configurations defined using different reference packages, such as a strict reference package and form factor, a flexible reference package and form factor, and a custom reference package for an original equipment manufacturer (OEM).

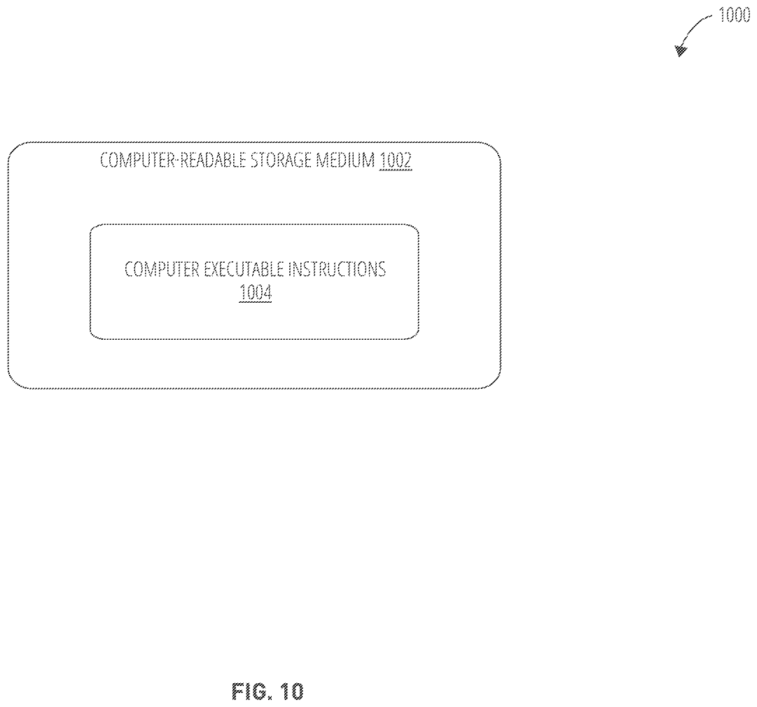

FIG. 10 illustrates an apparatus 1000. Apparatus 1000 may comprise any non-transitory computer-readable storage medium 1002 or machine-readable storage medium, such as an optical, magnetic or semiconductor storage medium. In various embodiments, apparatus 1000 may comprise an article of manufacture or a product. In some embodiments, the computer-readable storage medium 1002 may store computer executable instructions with which circuitry can execute. For example, computer executable instructions 1004 can include instructions to implement operations described with respect to any logic flows described herein. Examples of computer-readable storage medium 1002 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1004 may include any suitable type of code, such as source code, compiled code, interpreted code, executable code, static code, dynamic code, object-oriented code, visual code, and the like.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-18 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

In one example, a method, includes encoding a first configuration parameter for a mainband of a universal chiplet interconnect express (UCIe) interconnect into a first sideband signal, the first configuration parameter representing a first data rate for the mainband of the UCIe interconnect, decoding a second configuration parameter for the mainband of the UCIe interconnect from a second sideband signal, the second configuration parameter representing a second data rate for the mainband of the UCIe interconnect, decoding a third configuration parameter for the mainband of the UCIe interconnect from an application signal, the third configuration parameter representing a transport mode for the UCIe interconnect, and encoding information into a first mainband signal for transport over a transmit channel of the UCIe interconnect at the first data rate when the transport mode is set to an asymmetric mode for the UCIe interconnect.

The method of any preceding claim may also include decoding information from a second mainband signal from a receive channel of the UCIe interconnect at the second data rate when the transport mode is set to the asymmetric mode for the UCIe interconnect.

The method of any preceding claim may also include decoding information from a second mainband signal from a receive channel of the UCIe interconnect at the second data rate when the transport mode is set to the asymmetric mode for the UCIe interconnect using a third sideband signal, the third sideband signal includes a forwarded clock signal.

The method of any preceding claim may also include encoding information into the first mainband signal for transport over the transmit channel of the UCIe interconnect at a third data rate when the transport mode is set to a symmetric mode for the UCIe interconnect, the third data rate representing a least common multiple between the first data rate and the second data rate.

The method of any preceding claim may also include where the first data rate is different from the second data rate.

The method of any preceding claim may also include where the first data rate for the mainband of the UCIe interconnect represents a maximum transmit data rate and a maximum receive data rate of a first semiconductor die.

The method of any preceding claim may also include where the second data rate for the mainband of the UCIe interconnect represents a maximum transmit data rate and a maximum receive data rate of a second semiconductor die.

The method of any preceding claim may also include where the UCIe interconnect transports signals between multiple semiconductor dies in a semiconductor package. Other technical features may be readily apparent to one skilled in the art from the following figures, descriptions, and claims.

In one example, an apparatus, includes a universal chiplet interconnect express (UCIe) die includes a die-to-die (D2D) adapter coupled to a physical layer (PHY) for a UCIe interconnect, the UCIe interconnect includes interface logic to manage transport of data over the UCIe interconnect, the interface logic to encode a first configuration parameter for a mainband of the UCIe interconnect into a first sideband signal, the first configuration parameter representing a first data rate for the mainband of the UCIe interconnect, decode a second configuration parameter for the mainband of the UCIe interconnect from a second sideband signal, the second configuration parameter representing a second data rate for the mainband of the UCIe interconnect, decode a third configuration parameter for the mainband of the UCIe interconnect from an application signal, the third configuration parameter representing a transport mode for the UCIe interconnect, and encode information for a first mainband signal for transport over a transmit channel of the UCIe interconnect at the first data rate when the transport mode is set to an asymmetric mode for the UCIe interconnect.

The apparatus of any preceding claim may also include the interface logic to decode information from a second mainband signal from a receive channel of the UCIe interconnect at the second data rate when the transport mode is set to the asymmetric mode for the UCIe interconnect.

The apparatus of any preceding claim may also include the interface logic to decode information from a second mainband signal from a receive channel of the UCIe interconnect at the second data rate when the transport mode is set to the asymmetric mode for the UCIe interconnect using a third sideband signal, the third sideband signal includes a forwarded clock signal.

The apparatus of any preceding claim may also include the interface logic to encode information into the first mainband signal for transport over the transmit channel of the UCIe interconnect at a third data rate when the transport mode is set to a symmetric mode for the UCIe interconnect, the third data rate representing a least common multiple between the first data rate and the second data rate.

The apparatus of any preceding claim may also include where the first data rate is different from the second data rate.

The apparatus of any preceding claim may also include where the first data rate for the mainband of the UCIe interconnect represents a maximum transmit data rate and a maximum receive data rate of a first semiconductor die.

The apparatus of any preceding claim may also include where the second data rate for the mainband of the UCIe interconnect represents a maximum transmit data rate and a maximum receive data rate of a second semiconductor die.

The apparatus of any preceding claim may also include where the UCIe interconnect transports signals between multiple semiconductor dies in a semiconductor package. Other technical features may be readily apparent to one skilled in the art from the following figures, descriptions, and claims.

In one example, a system, includes a semiconductor package includes a first semiconductor die coupled by a universal chiplet interconnect express (UCIe) interconnect, the UCIe interconnect includes interface logic to manage transport of data over the UCIe interconnect, the interface logic to encode a first configuration parameter for a mainband of the UCIe interconnect into a first sideband signal, the first configuration parameter representing a first data rate for the mainband of the UCIe interconnect from the first semiconductor die, decode a second configuration parameter for the mainband of the UCIe interconnect from a second sideband signal, the second configuration parameter representing a second data rate for the mainband of the UCIe interconnect, decode a third configuration parameter for the mainband of the UCIe interconnect from an application signal, the third configuration parameter representing a transport mode for the UCIe interconnect, and encode information for a first mainband signal for transport over a transmit channel of the UCIe interconnect at the first data rate from the first semiconductor die when the transport mode is set to an asymmetric mode for the UCIe interconnect.

The system of any preceding claim may also include the semiconductor package includes a second semiconductor die coupled by the UCIe interconnect, and the interface logic to decode information from a second mainband signal from a receive channel of the UCIe interconnect at the second data rate transmitted from the second semiconductor die to the first semiconductor die when the transport mode is set to the asymmetric mode for the UCIe interconnect using a third sideband signal, the third sideband signal includes a forwarded clock signal.

The system of any preceding claim may also include where the first data rate for the mainband of the UCIe interconnect represents a maximum transmit data rate and a maximum receive data rate of the first semiconductor die.

The system of any preceding claim may also include where the second data rate for the mainband of the UCIe interconnect represents a maximum transmit data rate and a maximum receive data rate of a second semiconductor die. Other technical features may be readily apparent to one skilled in the art from the following figures, descriptions, and claims.

In one example, an apparatus, includes means for encoding a first configuration parameter for a mainband of a universal chiplet interconnect express (UCIe) interconnect into a first sideband signal, the first configuration parameter representing a first data rate for the mainband of the UCIe interconnect, means for decoding a second configuration parameter for the mainband of the UCIe interconnect from a second sideband signal, the second configuration parameter representing a second data rate for the mainband of the UCIe interconnect, means for decoding a third configuration parameter for the mainband of the UCIe interconnect from an application signal, the third configuration parameter representing a transport mode for the UCIe interconnect, and means for encoding information into a first mainband signal for transport over a transmit channel of the UCIe interconnect at the first data rate when the transport mode is set to an asymmetric mode for the UCIe interconnect.

The apparatus of any preceding claim may also include means for decoding information from a second mainband signal from a receive channel of the UCIe interconnect at the second data rate when the transport mode is set to the asymmetric mode for the UCIe interconnect.

The apparatus of any preceding claim may also include means for decoding information from a second mainband signal from a receive channel of the UCIe interconnect at the second data rate when the transport mode is set to the asymmetric mode for the UCIe interconnect using a third sideband signal, the third sideband signal includes a forwarded clock signal.

The apparatus of any preceding claim may also include means for encoding information into the first mainband signal for transport over the transmit channel of the UCIe interconnect at a third data rate when the transport mode is set to a symmetric mode for the UCIe interconnect, the third data rate representing a least common multiple between the first data rate and the second data rate.

The apparatus of any preceding claim may also include where the first data rate is different from the second data rate.

The apparatus of any preceding claim may also include where the first data rate for the mainband of the UCIe interconnect represents a maximum transmit data rate and a maximum receive data rate of a first semiconductor die.

The apparatus of any preceding claim may also include where the second data rate for the mainband of the UCIe interconnect represents a maximum transmit data rate and a maximum receive data rate of a second semiconductor die.

The apparatus of any preceding claim may also include where the UCIe interconnect transports signals between multiple semiconductor dies in a semiconductor package. Other technical features may be readily apparent to one skilled in the art from the following figures, descriptions, and claims.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method, comprising:
encoding a first configuration parameter for a mainband of a universal chiplet interconnect express (UCIe) interconnect into a first sideband signal, the first configuration parameter representing a first data rate for the mainband of the UCIe interconnect;
decoding a second configuration parameter for the mainband of the UCIe interconnect from a second sideband signal, the second configuration parameter representing a second data rate for the mainband of the UCIe interconnect;
decoding a third configuration parameter for the mainband of the UCIe interconnect from an application signal, the third configuration parameter representing a transport mode for the UCIe interconnect; and
encoding information into a first mainband signal for transport over a transmit channel of the UCIe interconnect at the first data rate when the transport mode is set to an asymmetric mode for the UCIe interconnect.

2. The method of claim 1, comprising decoding information from a second mainband signal from a receive channel of the UCIe interconnect at the second data rate when the transport mode is set to the asymmetric mode for the UCIe interconnect.

3. The method of claim 1, comprising decoding information from a second mainband signal from a receive channel of the UCIe interconnect at the second data rate when the transport mode is set to the asymmetric mode for the UCIe interconnect using a third sideband signal, the third sideband signal comprising a forwarded clock signal.

4. The method of claim 1, comprising encoding information into the first mainband signal for transport over the transmit channel of the UCIe interconnect at a third data rate when the transport mode is set to a symmetric mode for the UCIe interconnect, the third data rate representing a least common multiple between the first data rate and the second data rate.

5. The method of claim 1, wherein the first data rate is different from the second data rate.

6. The method of claim 1, wherein the first data rate for the mainband of the UCIe interconnect represents a maximum transmit data rate and a maximum receive data rate of a first semiconductor die.

7. The method of claim 1, wherein the second data rate for the mainband of the UCIe interconnect represents a maximum transmit data rate and a maximum receive data rate of a second semiconductor die.

8. The method of claim 1, wherein the UCIe interconnect transports signals between multiple semiconductor dies in a semiconductor package.

9. An apparatus, comprising:
a universal chiplet interconnect express (UCIe) die comprising a die-to-die (D2D) adapter coupled to a physical layer (PHY) for a UCIe interconnect, the UCIe interconnect comprising interface logic to manage transport of data over the UCIe interconnect, the interface logic to:
encode a first configuration parameter for a mainband of the UCIe interconnect into a first sideband signal, the first configuration parameter representing a first data rate for the mainband of the UCIe interconnect;
decode a second configuration parameter for the mainband of the UCIe interconnect from a second sideband signal, the second configuration parameter representing a second data rate for the mainband of the UCIe interconnect;
decode a third configuration parameter for the mainband of the UCIe interconnect from an application signal, the third configuration parameter representing a transport mode for the UCIe interconnect; and
encode information for a first mainband signal for transport over a transmit channel of the UCIe interconnect at the first data rate when the transport mode is set to an asymmetric mode for the UCIe interconnect.

10. The apparatus of claim 9, the interface logic to decode information from a second mainband signal from a receive channel of the UCIe interconnect at the second data rate when the transport mode is set to the asymmetric mode for the UCIe interconnect.

11. The apparatus of claim 9, the interface logic to decode information from a second mainband signal from a receive channel of the UCIe interconnect at the second data rate when the transport mode is set to the asymmetric mode for the UCIe interconnect using a third sideband signal, the third sideband signal comprising a forwarded clock signal.

12. The apparatus of claim 9, the interface logic to encode information into the first mainband signal for transport over the transmit channel of the UCIe interconnect at a third data rate when the transport mode is set to a symmetric mode for the UCIe interconnect, the third data rate representing a least common multiple between the first data rate and the second data rate.

13. The apparatus of claim 9, wherein the first data rate is different from the second data rate.

14. The apparatus of claim 9, wherein the first data rate for the mainband of the UCIe interconnect represents a maximum transmit data rate and a maximum receive data rate of a first semiconductor die.

15. The apparatus of claim 9, wherein the second data rate for the mainband of the UCIe interconnect represents a maximum transmit data rate and a maximum receive data rate of a second semiconductor die.

16. The apparatus of claim 9, wherein the UCIe interconnect transports signals between multiple semiconductor dies in a semiconductor package.

17. A system, comprising:
a semiconductor package comprising a first semiconductor die coupled by a universal chiplet interconnect express (UCIe) interconnect, the UCIe interconnect comprising interface logic to manage transport of data over the UCIe interconnect, the interface logic to:
encode a first configuration parameter for a mainband of the UCIe interconnect into a first sideband signal, the first configuration parameter representing a first data rate for the mainband of the UCIe interconnect from the first semiconductor die;
decode a second configuration parameter for the mainband of the UCIe interconnect from a second sideband signal, the second configuration parameter representing a second data rate for the mainband of the UCIe interconnect;
decode a third configuration parameter for the mainband of the UCIe interconnect from an application signal, the third configuration parameter representing a transport mode for the UCIe interconnect; and
encode information for a first mainband signal for transport over a transmit channel of the UCIe interconnect at the first data rate from the first semiconductor die when the transport mode is set to an asymmetric mode for the UCIe interconnect.

18. The system of claim 17, comprising:
the semiconductor package comprising a second semiconductor die coupled by the UCIe interconnect; and
the interface logic to decode information from a second mainband signal from a receive channel of the UCIe interconnect at the second data rate transmitted from the second semiconductor die to the first semiconductor die when the transport mode is set to the asymmetric mode for the UCIe interconnect using a third sideband signal, the third sideband signal comprising a forwarded clock signal.

19. The system of claim 17, wherein the first data rate for the mainband of the UCIe interconnect represents a maximum transmit data rate and a maximum receive data rate of the first semiconductor die.

20. The system of claim 17, wherein the second data rate for the mainband of the UCIe interconnect represents a maximum transmit data rate and a maximum receive data rate of a second semiconductor die.
